(19) United States
(12) Patent Application Publication
(10) Pub. No.: US 2024/0012295 A1
(43) Pub. Date: Jan. 11, 2024

(54) BACKLIGHT MODULE AND LIQUID CRYSTAL DISPLAY DEVICE

(71) Applicant: WUHAN CHINA STAR OPTOELECTRONICS TECHNOLOGY CO., LTD., Wuhan, Hubei (CN)

(72) Inventors: Rui HE, Wuhan, Hubei (CN); Wei CHENG, Wuhan, Hubei (CN); Qian DENG, Wuhan, Hubei (CN); Changchih HUANG, Wuhan, Hubei (CN); Guanghui LIU, Wuhan, Hubei (CN)

(21) Appl. No.: 17/289,014

(22) PCT Filed: Apr. 15, 2021
(86) PCT No.: PCT/CN2021/087530

§ 371 Date: Oct. 6, 2022

(30) Foreign Application Priority Data
Mar. 31, 2021 (CN) 202110349493.X

(51) Int. Cl. G02F 1/1343; G02F 1/137; G02F 1/139

(52) U.S. Cl. CPC G02F 1/134309; G02F 1/13706; G02F 1/13712; G02F 1/1393; G02F 1/1396; G02F 2202/04

(57) ABSTRACT

A backlight module and a liquid crystal display device are provided. The backlight module includes a light source and a dye-doped liquid crystal panel. The light source is configured to provide light to the dye-doped liquid crystal panel; and the dye-doped liquid crystal panel includes a plurality of dye-doped liquid crystal units, which allow the light incident on themselves to pass through when in a first state and regulate the light incident on themselves when in a second state, thereby realizing regulation of backlight partitions in a pixel level and improving a contrast ratio of the liquid crystal display device.

### FIELD OF INVENTION

The present disclosure relates to the field of display technologies, and more particularly, to a backlight module and a liquid crystal display device.

### BACKGROUND OF INVENTION

Contrast ratios of display devices have a key influence on display effect. In general, a higher contrast ratio means clearer and more eye-catching images displayed by the display devices, as well as brighter colors. For liquid crystal display devices, in order to improve contrast ratios of the liquid crystal display devices, partitioned backlight modules based on a plurality of mini-light-emitting diodes are usually used as backlight modules of the liquid crystal display devices. Partitioned regulation of backlight can be realized by the backlight modules, thereby improving the contrast ratios of the liquid crystal display devices.

However, due to a size limitation of the mini-light-emitting diodes, it is difficult for the partitioned backlight modules based on the plurality of mini-light-emitting diodes to realize regulation of backlight partitions in a pixel level. Therefore, it is difficult to further improve the contrast ratios of the liquid crystal display devices.

Technical problem: the present disclosure provides a backlight module and a liquid crystal display device to solve a problem of lower contrast ratios in current liquid crystal display devices.

### SUMMARY OF INVENTION

In a first aspect, the present disclosure provides a backlight module,
which includes a light source and a dye-doped liquid crystal panel;
wherein, the light source is configured to provide light to the dye-doped liquid crystal panel; and
the dye-doped liquid crystal panel includes a dye-doped liquid crystal layer including a plurality of dye-doped liquid crystal units, each of the dye-doped liquid crystal units includes a plurality of liquid crystal molecules and a plurality of dye molecules, and the dye-doped liquid crystal units allow the light incident on themselves to pass through when in a first state and regulate the light incident on themselves when in a second state.

In some embodiments, the dye-doped liquid crystal panel further includes a first substrate and a second substrate disposed on two opposite sides of the dye-doped liquid crystal layer.

In some embodiments, a first electrode layer is disposed on one side of the first substrate adjacent to the second substrate, the first electrode layer includes a plurality of first electrodes disposed at intervals, and the first electrodes correspond to the dye-doped liquid crystal units by one to one.

In some embodiments, a second electrode layer is disposed on one side of the second substrate adjacent to the first substrate, the second electrode layer includes a plurality of second electrodes disposed at intervals, and the second electrodes correspond to the dye-doped liquid crystal units by one to one.

In some embodiments, the liquid crystal molecules are cholesteric liquid crystal molecules and have a positive polarity, the first state is a power-on state, and the second state is a power-off state.

In some embodiments, a first alignment film is disposed on one side of the first electrode layer away from the first substrate, and a second alignment film is disposed on one side of the second electrode layer away from the second substrate.

In some embodiments, the first alignment film and the second alignment film adopt a twisted nematic alignment method, the liquid crystal molecules have a positive polarity, the first state is a power-on state, and the second state is a power-off state.

In some embodiments, the dye molecules include azo groups or anthraquinone groups.

In a second aspect, the present disclosure provides a liquid crystal display device, which includes a liquid crystal display panel and a backlight module,
wherein, the backlight module includes a light source and a dye-doped liquid crystal panel;
wherein, the light source is configured to provide light to the dye-doped liquid crystal panel; and
the dye-doped liquid crystal panel includes a dye-doped liquid crystal layer including a plurality of dye-doped liquid crystal units, each of the dye-doped liquid crystal units includes a plurality of liquid crystal molecules and a plurality of dye molecules, and the dye-doped liquid crystal units allow the light incident on themselves to pass through when in a first state and regulate the light incident on themselves when in a second state.

In some embodiments, the dye-doped liquid crystal panel further includes a first substrate and a second substrate disposed on two opposite sides of the dye-doped liquid crystal layer.

In some embodiments, a first electrode layer is disposed on one side of the first substrate adjacent to the second substrate, the first electrode layer includes a plurality of first electrodes disposed at intervals, and the first electrodes correspond to the dye-doped liquid crystal units by one to one.

In some embodiments, a second electrode layer is disposed on one side of the second substrate adjacent to the first substrate, the second electrode layer includes a plurality of second electrodes disposed at intervals, and the second electrodes correspond to the dye-doped liquid crystal units by one to one.

In some embodiments, the liquid crystal molecules are cholesteric liquid crystal molecules and have a positive polarity, the first state is a power-on state, and the second state is a power-off state.

In some embodiments, a first alignment film is disposed on one side of the first electrode layer away from the first substrate, and a second alignment film is disposed on one side of the second electrode layer away from the second substrate.

In some embodiments, the first alignment film and the second alignment film adopt a twisted nematic alignment method, the liquid crystal molecules have a positive polarity, the first state is a power-on state, and the second state is a power-off state.

In some embodiments, a polarizer is disposed on one side of the liquid crystal display panel adjacent to the backlight module, and the polarizer is configured to cooperate with the dye-doped liquid crystal units to allow the light incident on the dye-doped liquid crystal units to pass through when the dye-doped liquid crystal units are in the first state and to regulate the light incident on the dye-doped liquid crystal units when the dye-doped liquid crystal units are in the second state.

In some embodiments, the first alignment film and the second alignment film adopt a vertical alignment method, the liquid crystal molecules have a negative polarity, the first state is a power-off state, the second state is a power-on state, and a light-absorbing direction of the polarizer is perpendicular to a long axis direction of the liquid crystal molecules in the second state.

In some embodiments, the first alignment film and the second alignment film adopt an electrically controlled birefringence alignment method, the liquid crystal molecules have a positive polarity, the first state is a power-on state, the second state is a power-off state, and a light-absorbing direction of the polarizer is perpendicular to a long axis direction of the liquid crystal molecules in the second state.

In some embodiments, the liquid crystal display panel includes a plurality of sub-pixel units, and the dye-doped liquid crystal units in the backlight module correspond to the sub-pixel units by one to one.

In some embodiments, the dye molecules include azo groups or anthraquinone groups.

Beneficial effect: the backlight module provided by the present disclosure is applied to the liquid crystal display device. The backlight module can control brightness of each of the sub-pixel units in the liquid crystal display panel by controlling states of each of the dye-doped liquid crystal units in the dye-doped liquid crystal panel, thereby realizing regulation of backlight partitions in a pixel level and improving a contrast ratio of the liquid crystal display device.

### DESCRIPTION OF DRAWINGS

FIG. 1 is a schematic structural diagram of a liquid crystal display device according to an embodiment of the present disclosure.

FIG. 2 is a schematic structural diagram of the liquid crystal display device according to another embodiment of the present disclosure.

FIG. 3 is a schematic structural diagram of the liquid crystal display device according to yet another embodiment of the present disclosure.

### DETAILED DESCRIPTION OF PREFERRED EMBODIMENTS

In order to make the purpose, technical solutions, and effects of the present disclosure clearer and more definite, the following further describes the present disclosure in detail with reference to the drawings and embodiments. It should be understood that the specific embodiments described herein are only used to explain the disclosure, and are not used to limit the disclosure.

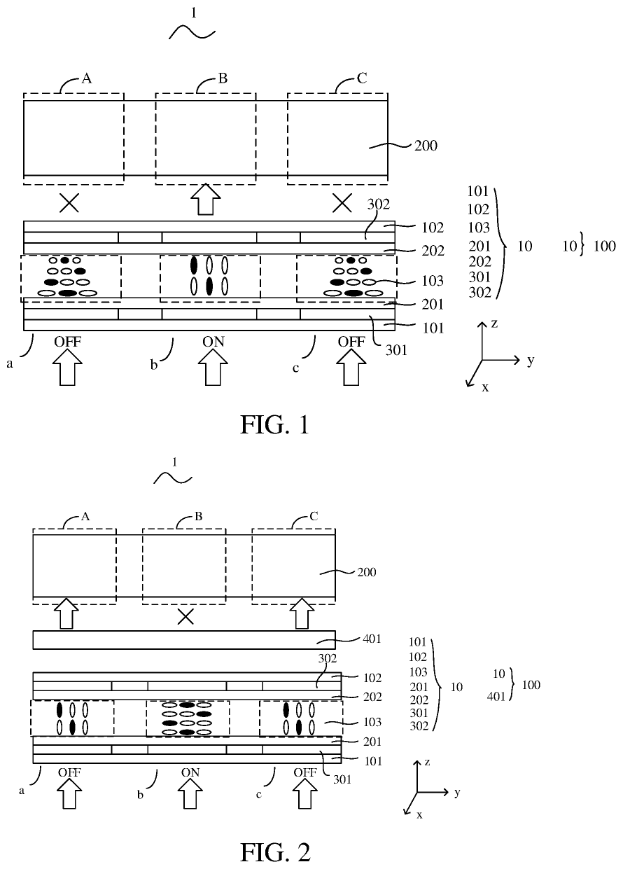

An embodiment of the present disclosure provides a backlight module, and applying the backlight module to a liquid crystal display device can realize regulation of backlight partitions in a pixel level, thereby improving a contrast ratio of the liquid crystal display device. A structure of the liquid crystal display device obtained by applying the backlight module to the liquid crystal display device is shown in FIG. 1. The liquid crystal display device 1 includes a liquid crystal display panel 200 and a backlight module 100 configured to provide backlight for the liquid crystal display panel 200.

Wherein, the liquid crystal display panel 200 includes a plurality of sub-pixel units arranged in an array.

The backlight module 100 includes a light source (not shown in FIG. 1) and a dye-doped liquid crystal panel 10. Wherein, the dye-doped liquid crystal panel 10 is disposed on one side of the liquid crystal display panel 200, the light source is disposed on one side of the dye-doped liquid crystal panel 10 away from the liquid crystal display panel 200, and the light source is configured to provide light to the dye-doped liquid crystal panel 10. The dye-doped liquid crystal panel 10 includes a dye-doped liquid crystal layer 103, the dye-doped liquid crystal layer 103 includes a plurality of dye-doped liquid crystal units (dotted frames in the dye-doped liquid crystal layer 103 shown in FIG. 1) arranged in an array, and the dye-doped liquid crystal units correspond to the sub-pixel units by one to one. Each of the dye-doped liquid crystal units includes a plurality of liquid crystal molecules (circles which are not filled with any color shown in FIG. 1) and a plurality of dye molecules (circles filled with black color shown in FIG. 1). The dye molecules are bound by molecular free energies, and will rotate with rotation of the liquid crystal molecules. Long axis directions of the dye molecules are consistent with long axis directions of the liquid crystal molecules, and the dye molecules are configured to absorb polarized light that is parallel to the long axis directions thereof. Each of the dye-doped liquid crystal units is configured to allow light incident on itself to emit to one corresponding sub-pixel unit when in a first state, thereby providing backlight to the corresponding sub-pixel unit and making the corresponding sub-pixel unit be in a bright state. Each of the dye-doped liquid crystal units is also configured to regulate the light incident on itself when in a second state, thereby preventing the light from emitting to the corresponding sub-pixel unit and allowing the corresponding sub-pixel unit to be in a dark state.

It can be understood that since the dye-doped liquid crystal panel 10 includes the dye-doped liquid crystal units corresponding to the sub-pixel units in the liquid crystal display panel 200 by one to one, and each of the dye-doped liquid crystal units can control the light incident on itself to emit to the corresponding sub-pixel unit or not when in different states, brightness of each of the sub-pixel units in the liquid crystal display panel 200 can be controlled by controlling the states of each of the dye-doped liquid crystal units in the dye-doped liquid crystal panel 10, thereby realizing the regulation of backlight partitions in the pixel level and improving the contrast ratio of the liquid crystal display device 1.

Referring to FIG. 1, the dye-doped liquid crystal panel 10 in the embodiment further includes a first substrate 101 and a second substrate 102 disposed on two opposite sides of the dye-doped liquid crystal layer 103. Wherein, the first substrate 101, the dye-doped liquid crystal layer 103, and the second substrate 102 are disposed in sequence along an incident direction of light (the direction indicated by an arrow shown in FIG. 1). Both the first substrate 101 and the second substrate 102 may use a rigid transparent substrate such as a glass substrate or may use a flexible transparent substrate, and is not specifically limited herein.

A first electrode layer is disposed on one side of the first substrate 101 adjacent to the second substrate 102, the first electrode layer includes a plurality of first electrodes 301 disposed at intervals, and the first electrodes 301 correspond to the dye-doped liquid crystal units by one to one. A second electrode layer is disposed on one side of the second substrate 102 adjacent to the first substrate 101, the second electrode layer includes a plurality of second electrodes 302 disposed at intervals, and the second electrodes 302 correspond to the dye-doped liquid crystal units by one to one. That is, the first electrodes 301 and the second electrodes 302 can form vertical electric fields, thereby driving the liquid crystal molecules and the dye molecules in the dye-doped liquid crystal units to rotate.

A first alignment film 201 is further disposed on one side of the first electrode layer away from the first substrate 101, and a second alignment film 202 is further disposed on one side of the second electrode layer away from the second substrate 102. Wherein, the first alignment film 201 and the second alignment film 202 can be made of materials such as organic resins by methods such as a rubbing alignment method or an optical alignment method, and is not specifically limited herein. An initial state of the liquid crystal molecules and the dye molecules can be adjusted by arranging alignment methods of the first alignment film 201 and the second alignment film 202.

Referring to FIG. 1, a three-dimensional Cartesian coordinate system is defined, and three coordinate axes are defined as an x-axis (a direction perpendicular to a paper surface), a y-axis (a horizontal direction within the paper surface and perpendicular to the x-axis), and a z-axis (a vertical direction within the paper surface and perpendicular to the x-axis and the y-axis), respectively. The first alignment film 201 and the second alignment film 202 adopt a twisted nematic alignment method. Wherein, an alignment direction of the first alignment film 201 is horizontal, an alignment direction of the second alignment film 202 is perpendicular to the paper surface, the liquid crystal molecules have a positive polarity, the first state is a power-on state, and the second state is a power-off state.

Specifically, the liquid crystal display device 1 shown in FIG. 1 includes the liquid crystal display panel 200 and the backlight module 100, and the backlight module 100 includes the light source and the dye-doped liquid crystal panel 10. Wherein, three sub-pixel units are shown in the liquid crystal display panel 200, three dye-doped liquid crystal units corresponding to the three sub-pixel units by one to one are shown in the dye-doped liquid crystal panel 10, and for convenience of description, the three sub-pixel units are called sub-pixel unit A, sub-pixel unit B, and sub-pixel unit C, respectively, in an order from left to right, and the three dye-doped liquid crystal units are called dye-doped liquid crystal unit a, dye-doped liquid crystal unit b, and dye-doped liquid crystal unit c, respectively, in the order from left to right.

Both the dye-doped liquid crystal unit a and the dye-doped liquid crystal unit c are in the power-off state (OFF shown in FIG. 1 represents the power-off state). Since the two are in a same state, here, only one of the dye-doped liquid crystal units, for example, the dye-doped liquid crystal unit a, is taken as an example for description. When the dye-doped liquid crystal unit a is in the power-off state, it means that no driving voltage is applied to one of the first electrodes 301 and one of the second electrodes 302 corresponding to the dye-doped liquid crystal unit a. At this time, there is no electric field in the dye-doped liquid crystal unit a, and the liquid crystal molecules and the dye molecules in the dye-doped liquid crystal unit a are all arranged in a spiral shape. Specifically, on one side adjacent to the first substrate 101, the long axis directions of the liquid crystal molecules and the dye molecules are all horizontal, on another side adjacent to the second substrate 102, the long axis directions of the liquid crystal molecules and the dye molecules are all perpendicular to the paper surface, and along a direction from the first substrate 101 to the second substrate 102, the long axis directions of the liquid crystal molecules and the dye molecules are gradually changing from horizontal to perpendicular to the paper surface, thereby forming a spiral structure having a greatest angle difference being 90 degrees. At this time, for light that is emitted to the dye-doped liquid crystal unit a, a vibrating direction thereof is perpendicular to the z-axis, and in a vibrating plane thereof, the light vibrating along every direction can be divided into polarized light in a horizontal direction and polarized light that is perpendicular to the paper surface. Since the long axis directions of a part of the dye molecules are horizontal and the long axis directions of another part of the dye molecules are perpendicular to the paper surface, the part of the dye molecules having a horizontal long axis direction can absorb the polarized light in the horizontal direction, and the part of the dye molecules having the long axis directions that are perpendicular to the paper surface can absorb the polarized light that is perpendicular to the paper surface. That is, the dye-doped liquid crystal unit a can absorb the light incident on itself, thereby preventing the light from emitting to the sub-pixel unit A and allowing the sub-pixel unit A to be in the dark state.

When the dye-doped liquid crystal unit b is in the power-on state (ON shown in FIG. 1 represents the power-on state), it means that a driving voltage is applied to one of the first electrodes 301 and one of the second electrodes 302 corresponding to the dye-doped liquid crystal unit b, which allows a vertical electric field to be formed in the dye-doped liquid crystal unit b. Since the liquid crystal molecules have the positive polarity, under effect of the electric field, the long axis directions of the liquid crystal molecules having the positive polarity are parallel to a direction of the electric field. Therefore, the long axis directions of the liquid crystal molecules and the dye molecules in the dye-doped liquid crystal unit b are all vertical. At this time, for light that is emitted to the dye-doped liquid crystal unit b, a vibrating direction thereof is perpendicular to the z-axis, that is perpendicular to the long axis directions of the dye molecules, so the dye molecules cannot absorb the light, that is, the dye-doped liquid crystal unit b can allow the light incident on itself to emit to the sub-pixel unit B, thereby providing backlight for the sub-pixel unit B and allowing the sub-pixel unit B to be in the bright state.

As a preferred embodiment, this embodiment provides a driving method for driving the liquid crystal display device 1 shown in FIG. 1. The driving method specifically includes following steps.

Step S101: when one of the sub-pixel units in the liquid crystal display panel 200 is needed to be in the dark state, apply no driving voltage to one of the dye-doped liquid crystal units corresponding thereto. At this time, the liquid crystal molecules and the dye molecules are all arranged in the spiral shape, so this dye-doped liquid crystal unit absorbs the light incident on itself, thereby preventing the light from emitting to the corresponding sub-pixel unit.

Step S102: when one of the sub-pixel units in the liquid crystal display panel 200 is needed to be in the bright state, apply the driving voltage to one of the dye-doped liquid crystal units corresponding thereto. At this time, the long axis directions of the liquid crystal molecules and the dye molecules are all vertical, so this dye-doped liquid crystal unit does not absorb the light incident on itself, thereby allowing the light to emit to the corresponding sub-pixel unit.

It should be noted that the step S101 and the step S102 do not have a sequential relationship.

In some embodiments, the liquid crystal molecules may use cholesteric liquid crystal molecules having positive polarity. At this time, compared to the dye-doped liquid crystal panel 10 in the display device 1 shown in FIG. 1, a corresponding dye-doped liquid crystal panel thereof may also omit the first alignment film 201 and the second alignment film 202.

That is, the dye-doped liquid crystal panel using the cholesteric liquid crystal molecules may only include the first substrate and the second substrate disposed on the two opposite sides of the dye-doped liquid crystal layer 103, the first electrode layer disposed on the side of the first substrate adjacent to the second substrate, and the second electrode layer disposed on the side of the second substrate adjacent to the first substrate.

For one of the dye-doped liquid crystal units, if this dye-doped liquid crystal unit is in the power-off state, the liquid crystal molecules and the dye molecules in this dye-doped liquid crystal unit are all arranged in the spiral shape, so this dye-doped liquid crystal unit absorbs the light incident on itself, thereby preventing the light from emitting to one of the sub-pixel units corresponding thereto. If this dye-doped liquid crystal unit is in the power-on state, the long axis directions of the liquid crystal molecules and the dye molecules in this dye-doped liquid crystal unit are all vertical, so this dye-doped liquid crystal unit does not absorb the light incident on itself, thereby allowing the light to emit to the one of the sub-pixel units corresponding thereto. A structure of this dye-doped liquid crystal panel is similar to a structure of the dye-doped liquid crystal panel 10 in the liquid crystal display device 1 shown in FIG. 1, and working principles thereof are also similar to each other, so they are not repeated herein.

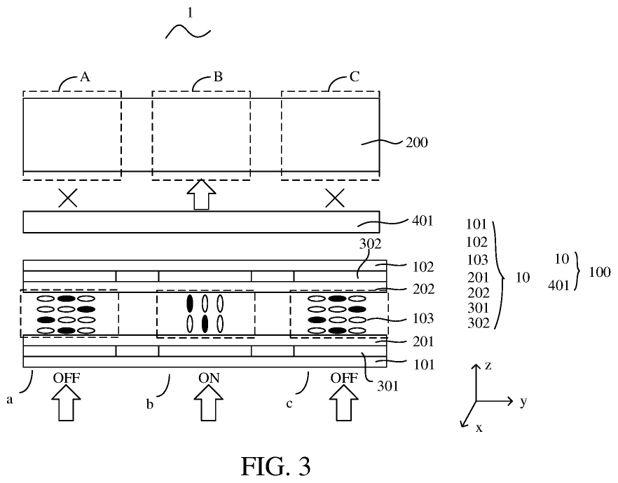

In order to improve the contrast ratio of the liquid crystal display device 1, the embodiments of the present disclosure further provide two kinds of liquid crystal display devices 1 to realize the regulation of backlight partitions in the pixel level, thereby improving the contrast ratio of the liquid crystal display device 1. Structures of the two kinds of liquid crystal display devices 1 provided by the embodiments of the present disclosure are shown in FIGS. 2 and 3. Referring to FIGS. 2 and 3, the liquid crystal display device 1 includes the liquid crystal display panel 200 and the backlight module 100 configured to provide the backlight for the liquid crystal display panel 200.

Wherein, the liquid crystal display panel 200 includes the plurality of sub-pixel units arranged in the array. A polarizer 401 is disposed on one side of the liquid crystal display panel 200 adjacent to the backlight module 100.

The backlight module 100 includes the light source (not shown in FIGS. 2 and 3) and the dye-doped liquid crystal panel 10. Wherein, the light source is disposed on the side of the dye-doped liquid crystal panel 10 away from the polarizer 401, and the light source is configured to provide the light to the dye-doped liquid crystal panel 10. The dye-doped liquid crystal panel 10 includes the plurality of dye-doped liquid crystal units (dotted frames in the dye-doped liquid crystal layer 103 shown in FIGS. 2 and 3) arranged in the array, and the dye-doped liquid crystal units correspond to the sub-pixel units by one to one. The polarizer 401 is configured to cooperate with the dye-doped liquid crystal units to allow the light incident on the dye-doped liquid crystal units to emit to corresponding sub-pixel units when the dye-doped liquid crystal units are in the first state, thereby providing the backlight to the corresponding sub-pixel units and allowing the corresponding sub-pixel units to be in the bright state. The polarizer 401 is also configured to cooperate with the dye-doped liquid crystal units to regulate the light incident on the dye-doped liquid crystal units when the dye-doped liquid crystal units are in the second state, thereby preventing the light from emitting to the corresponding sub-pixel units and allowing the corresponding sub-pixel units to be in the dark state.

It can be understood that since the dye-doped liquid crystal panel 10 includes the dye-doped liquid crystal units corresponding to the sub-pixel units in the liquid crystal display panel 200 by one to one, and the polarizer 401 can cooperate with the dye-doped liquid crystal units to control the light incident on the dye-doped liquid crystal units to emit to the corresponding sub-pixel unit or not when the dye-doped liquid crystal units are in the different states, the brightness of each of the sub-pixel units in the liquid crystal display panel 200 can be controlled by controlling the states of each of the dye-doped liquid crystal units in the dye-doped liquid crystal panel 10, thereby realizing the regulation of backlight partitions in the pixel level and improving the contrast ratio of the liquid crystal display device 1.

Referring to FIGS. 2 and 3, the dye-doped liquid crystal panel 10 in the embodiments further includes the first substrate 101 and the second substrate 102 disposed on the two opposite sides of the dye-doped liquid crystal layer 103. Wherein, the first substrate 101, the dye-doped liquid crystal layer 103, and the second substrate 102 are disposed in sequence along the incident direction of light (the direction indicated by arrows shown in FIGS. 2 and 3). Both the first substrate 101 and the second substrate 102 may use the rigid transparent substrate such as the glass substrate or may use the flexible transparent substrate, and is not specifically limited herein.

The first electrode layer is disposed on the side of the first substrate 101 adjacent to the second substrate 102, the first electrode layer includes the plurality of first electrodes 301 disposed at intervals, and the first electrodes 301 correspond to the dye-doped liquid crystal units by one to one. The second electrode layer is disposed on the side of the second substrate 102 adjacent to the first substrate 101, the second electrode layer includes the plurality of second electrodes 302 disposed at intervals, and the second electrodes 302 correspond to the dye-doped liquid crystal units by one to one. That is, the first electrodes 301 and the second electrodes 302 can form the vertical electric fields, thereby driving the liquid crystal molecules and the dye molecules in the dye-doped liquid crystal units to rotate.

The first alignment film 201 is further disposed on the side of the first electrode layer away from the first substrate 101, and the second alignment film 202 is further disposed on the side of the second electrode layer away from the second substrate 102. Wherein, the first alignment film 201 and the second alignment film 202 can be made of materials such as organic resins by methods such as the rubbing alignment method or the optical alignment method, and is not specifically limited herein. The initial state of the liquid crystal molecules and the dye molecules can be adjusted by arranging the alignment methods of the first alignment film 201 and the second alignment film 202.

For the liquid crystal display device 1 shown in FIG. 2, the three-dimensional Cartesian coordinate system is defined, and the three coordinate axes are defined as the x-axis (the direction perpendicular to the paper surface), the y-axis (the horizontal direction within the paper surface and perpendicular to the x-axis), and the z-axis (the vertical direction within the paper surface and perpendicular to the x-axis and the y-axis), respectively. The first alignment film 201 and the second alignment film 202 adopt a vertical alignment method. Wherein, the alignment direction of the first alignment film 201 is vertical, the alignment direction of the second alignment film 202 is vertical, the liquid crystal molecules have a negative polarity, the first state is the power-off state, and the second state is the power-on state.

Specifically, the liquid crystal display device 1 shown in FIG. 2 includes the liquid crystal display panel 200 and the backlight module 100, and the backlight module 100 includes the dye-doped liquid crystal panel 10. Wherein, the three sub-pixel units are shown in the liquid crystal display panel 200, the three dye-doped liquid crystal units corresponding to the three sub-pixel units by one to one are shown in the dye-doped liquid crystal panel 10, and for convenience of description, the three sub-pixel units are called sub-pixel unit A, sub-pixel unit B, and sub-pixel unit C, respectively, in the order from left to right, and the three dye-doped liquid crystal units are called dye-doped liquid crystal unit a, dye-doped liquid crystal unit b, and dye-doped liquid crystal unit c, respectively, in the order from left to right.

Both the dye-doped liquid crystal unit a and the dye-doped liquid crystal unit c are in the power-off state (OFF shown in FIG. 2 represents the power-off state). Since the two are in the same state, here, only one of the dye-doped liquid crystal units, for example, the dye-doped liquid crystal unit a, is taken as an example for description. When the dye-doped liquid crystal unit a is in the power-off state, it means that no driving voltage is applied to the one of the first electrodes 301 and the one of the second electrodes 302 corresponding to the dye-doped liquid crystal unit a. At this time, there is no electric field in the dye-doped liquid crystal unit a, and the long axis directions of the liquid crystal molecules and the dye molecules in this dye-doped liquid crystal unit a are all vertical. At this time, for light that is emitted to the dye-doped liquid crystal unit a, the vibrating direction thereof is perpendicular to the z-axis, that is perpendicular to the long axis directions of the dye molecules, so the dye molecules cannot absorb the light. That is, the dye-doped liquid crystal unit a can allow the light incident on itself to pass through the polarizer 401 to generate polarized light, and then to emit to the sub-pixel unit A, thereby providing backlight for the sub-pixel unit A and allowing the sub-pixel unit A to be in the bright state.

When the dye-doped liquid crystal unit b is in the power-on state (ON shown in FIG. 2 represents the power-on state), it means that the driving voltage is applied to the one of the first electrodes 301 and the one of the second electrodes 302 corresponding to the dye-doped liquid crystal unit b, which allows the vertical electric field to be formed in the dye-doped liquid crystal unit b. Since the liquid crystal molecules have the negative polarity, under the effect of the electric field, the long axis directions of the liquid crystal molecules having the negative polarity are perpendicular to the direction of the electric field. Therefore, the long axis directions of the liquid crystal molecules and the dye molecules in the dye-doped liquid crystal unit b are all horizontal. At this time, for the light that is emitted to the dye-doped liquid crystal unit b, the vibrating direction thereof is perpendicular to the z-axis, and in the vibrating plane thereof, the light vibrating along every direction can be divided into the polarized light in the horizontal direction and the polarized light that is perpendicular to the paper surface. Since the dye molecules having the horizontal long axis direction can absorb the polarized light in the horizontal direction, the polarized light that is perpendicular to the paper surface can be emitted to the polarizer 401. Since a light-absorbing direction of the polarizer 401 is perpendicular to the long axis directions of the liquid crystal molecules in this dye-doped liquid crystal unit, that is, the light-absorbing direction of the polarizer 401 is perpendicular to the paper surface, the polarizer 401 can fully absorb the polarized light that is perpendicular to the paper surface. That is, the polarizer 401 can cooperate with this dye-doped liquid crystal unit to absorb the light incident on this dye-doped liquid crystal unit, thereby preventing the light from emitting to the sub-pixel unit B, and allowing the sub-pixel unit B to be in the dark state.

As a preferred embodiment, this embodiment provides a driving method for driving the liquid crystal display device 1 shown in FIG. 2. The driving method specifically includes following steps.

Step S201: when one of the sub-pixel units in the liquid crystal display panel 200 is needed to be in the dark state, apply the driving voltage to one of the dye-doped liquid crystal units corresponding thereto. At this time, the long axis directions of the liquid crystal molecules and the dye molecules are all horizontal, and this dye-doped liquid crystal unit cooperates with the polarizer 401 to absorb the light incident on itself, thereby preventing the light from emitting to the corresponding sub-pixel unit.

Step S202: when the one of the sub-pixel units in the liquid crystal display panel 200 is needed to be in the bright state, apply no driving voltage to the one of the dye-doped liquid crystal units corresponding thereto. At this time, the long axis directions of the liquid crystal molecules and the dye molecules are all vertical, and this dye-doped liquid crystal unit does not absorb the light incident on itself, thereby allowing the light to pass through the polarizer 401 and then to emit to the corresponding sub-pixel unit.

It should be noted that the step S201 and the step S202 do not have a sequential relationship.

For the liquid crystal display device 1 shown in FIG. 3, the three-dimensional Cartesian coordinate system is defined, and the three coordinate axes are defined as the x-axis (the direction perpendicular to the paper surface), the y-axis (the horizontal direction within the paper surface and perpendicular to the x-axis), and the z-axis (the vertical direction within the paper surface and perpendicular to the x-axis and the y-axis), respectively. The first alignment film 201 and the second alignment film 202 adopt an electrically controlled birefringence alignment method. Wherein, the alignment direction of the first alignment film 201 is horizontal, the alignment direction of the second alignment film 202 is horizontal, the liquid crystal molecules have the positive polarity, the first state is the power-on state, and the second state is the power-off state.

Specifically, the liquid crystal display device 1 shown in FIG. 3 includes the liquid crystal display panel 200 and the backlight module 100, and the backlight module 100 includes the dye-doped liquid crystal panel 10. Wherein, the three sub-pixel units are shown in the liquid crystal display panel 200, the three dye-doped liquid crystal units corresponding to the three sub-pixel units by one to one are shown in the dye-doped liquid crystal panel 10, and for convenience of description, the three sub-pixel units are called sub-pixel unit A, sub-pixel unit B, and sub-pixel unit C, respectively, in the order from left to right, and the three dye-doped liquid crystal units are called dye-doped liquid crystal unit a, dye-doped liquid crystal unit b, and dye-doped liquid crystal unit c, respectively, in the order from left to right.

Both the dye-doped liquid crystal unit a and the dye-doped liquid crystal unit c are in the power-off state (OFF shown in FIG. 3 represents the power-off state). Since the two are in the same state, here, only one of the dye-doped liquid crystal units, for example, the dye-doped liquid crystal unit a, is taken as an example for description. When the dye-doped liquid crystal unit a is in the power-off state, it means that no driving voltage is applied to the one of the first electrodes 301 and the one of the second electrodes 302 corresponding to the dye-doped liquid crystal unit a. At this time, there is no electric field in the dye-doped liquid crystal unit a, and the long axis directions of the liquid crystal molecules and the dye molecules in this dye-doped liquid crystal unit a are all horizontal. At this time, for the light that is emitted to the dye-doped liquid crystal unit a, the vibrating direction thereof is perpendicular to the z-axis, and in the vibrating plane thereof, the light vibrating along every direction can be divided into the polarized light in the horizontal direction and the polarized light that is perpendicular to the paper surface. Since the dye molecules having the horizontal long axis direction can absorb the polarized light in the horizontal direction, the polarized light that is perpendicular to the paper surface can be emitted to the polarizer 401. Since the light-absorbing direction of the polarizer 401 is perpendicular to the long axis directions of the liquid crystal molecules in this dye-doped liquid crystal unit, that is, the light-absorbing direction of the polarizer 401 is perpendicular to the paper surface, the polarizer 401 can fully absorb the polarized light that is perpendicular to the paper surface. That is, the polarizer 401 can cooperate with this dye-doped liquid crystal unit to absorb the light incident on this dye-doped liquid crystal unit, thereby preventing the light from emitting to the sub-pixel unit A, and allowing the sub-pixel unit A to be in the dark state.

When the dye-doped liquid crystal unit b is in the power-on state (ON shown in FIG. 3 represents the power-on state), it means that the driving voltage is applied to the one of the first electrodes 301 and the one of the second electrodes 302 corresponding to the dye-doped liquid crystal unit b, which allows the vertical electric field to be formed in the dye-doped liquid crystal unit b. Since the liquid crystal molecules have the positive polarity, under effect of the electric field, the long axis directions of the liquid crystal molecules having the positive polarity are parallel to the direction of the electric field. Therefore, the long axis directions of the liquid crystal molecules and the dye molecules in the dye-doped liquid crystal unit b are all vertical. At this time, for light that is emitted to the dye-doped liquid crystal unit b, the vibrating direction thereof is perpendicular to the z-axis, that is perpendicular to the long axis directions of the dye molecules, so the dye molecules cannot absorb the light. That is, the dye-doped liquid crystal unit b can allow the light incident on itself to pass through the polarizer 401 to generate the polarized light and then to emit to the sub-pixel unit B, thereby providing the backlight for the sub-pixel unit B and allowing the sub-pixel unit B to be in the bright state.

As a preferred embodiment, this embodiment provides a driving method for driving the liquid crystal display device 1 shown in FIG. 3. The driving method specifically includes following steps.

Step S301: when one of the sub-pixel units in the liquid crystal display panel 200 is needed to be in the dark state, apply no driving voltage to one of the dye-doped liquid crystal units corresponding thereto. At this time, the long axis directions of the liquid crystal molecules and the dye molecules are all horizontal, and this dye-doped liquid crystal unit cooperates with the polarizer 401 to absorb the light incident on itself, thereby preventing the light from emitting to the corresponding sub-pixel unit.

Step S302: when the one of the sub-pixel units in the liquid crystal display panel 200 is needed to be in the bright state, apply the driving voltage to the one of the dye-doped liquid crystal units corresponding thereto. At this time, the long axis directions of the liquid crystal molecules and the dye molecules are all vertical, and this dye-doped liquid crystal unit does not absorb the light incident on itself, thereby allowing the light to pass through the polarizer 401 and then to emit to the corresponding sub-pixel unit.

It should be noted that the step S301 and the step S302 do not have a sequential relationship.

In the embodiments of the present disclosure, the dye molecules include azo groups or anthraquinone groups. Further, regarding selection of the dye molecules, it is necessary to ensure the dye molecules in the liquid crystal molecules have higher order parameter and dichroic ratio, so that an arrangement order of the dye molecules and a contrast ratio of the dye-doped liquid crystal units can be ensured. In addition, the dye molecules need to have high stability to light and heat, and also need to have a high extinction coefficient.

For the liquid crystal display device 1 shown in FIG. 1, two adjacent functional layers among the liquid crystal display panel 200, the dye-doped liquid crystal panel 10, and the light source can be attached to each other and fixed with an optical adhesive layer, so light transmission can be ensured while reducing whole thickness of the liquid crystal display device 1.

It should be noted that the liquid crystal display device 1 may be a mobile phone, a computer, and a smart wearable device, and is not specifically limited herein.

It should be noted that in the embodiments mentioned above, the dye-doped liquid crystal units in the backlight module disposed corresponding to the sub-pixel units in the liquid crystal display panel by one to one are taken as the example for description, so that optimal regulation of the backlight partitions in the pixel level can be realized. Of course, in other embodiments, one dye-doped liquid crystal unit corresponds to a plurality of the sub-pixel units may also be adopted for realizing better regulation of the backlight partitions.

It can be understood that for a person of ordinary skill in the art, equivalent replacements or changes can be made according to the technical solution of the present disclosure and its inventive concept, and all these changes or replacements should fall within the protection scope of the claims attached to the present disclosure.

What is claimed is:

1. A backlight module, comprising a light source and a dye-doped liquid crystal panel;
wherein the light source is configured to provide light to the dye-doped liquid crystal panel; and
the dye-doped liquid crystal panel comprises a dye-doped liquid crystal layer comprising a plurality of dye-doped liquid crystal units, each of the dye-doped liquid crystal units comprises a plurality of liquid crystal molecules and a plurality of dye molecules, and the dye-doped liquid crystal units allow the light incident on themselves to pass through when in a first state and regulate the light incident on themselves when in a second state.

2. The backlight module according to claim 1, wherein the dye-doped liquid crystal panel further comprises a first substrate and a second substrate disposed on two opposite sides of the dye-doped liquid crystal layer.

3. The backlight module according to claim 2, wherein a first electrode layer is disposed on one side of the first substrate adjacent to the second substrate, the first electrode layer comprises a plurality of first electrodes disposed at intervals, and the first electrodes correspond to the dye-doped liquid crystal units by one to one.

4. The backlight module according to claim 3, wherein a second electrode layer is disposed on one side of the second substrate adjacent to the first substrate, the second electrode layer comprises a plurality of second electrodes disposed at intervals, and the second electrodes correspond to the dye-doped liquid crystal units by one to one.

5. The backlight module according to claim 4, wherein the liquid crystal molecules are cholesteric liquid crystal molecules and have a positive polarity, the first state is a power-on state, and the second state is a power-off state.

6. The backlight module according to claim 4, wherein a first alignment film is disposed on one side of the first electrode layer away from the first substrate, and a second alignment film is disposed on one side of the second electrode layer away from the second substrate.

7. The backlight module according to claim 6, wherein the first alignment film and the second alignment film adopt a twisted nematic alignment method, the liquid crystal molecules have a positive polarity, the first state is a power-on state, and the second state is a power-off state.

8. The backlight module according to claim 1, wherein the dye molecules comprise azo groups or anthraquinone groups.

9. A liquid crystal display device, comprising a liquid crystal display panel and a backlight module, wherein the backlight module comprises a light source and a dye-doped liquid crystal panel;
wherein the light source is configured to provide light to the dye-doped liquid crystal panel; and
the dye-doped liquid crystal panel comprises a dye-doped liquid crystal layer comprising a plurality of dye-doped liquid crystal units, each of the dye-doped liquid crystal units comprises a plurality of liquid crystal molecules and a plurality of dye molecules, and the dye-doped liquid crystal units allow the light incident on themselves to pass through when in a first state and regulate the light incident on themselves when in a second state.

10. The liquid crystal display device according to claim 9, wherein the dye-doped liquid crystal panel further comprises a first substrate and a second substrate disposed on two opposite sides of the dye-doped liquid crystal layer.

11. The liquid crystal display device according to claim 10, wherein a first electrode layer is disposed on one side of the first substrate adjacent to the second substrate, the first electrode layer comprises a plurality of first electrodes disposed at intervals, and the first electrodes correspond to the dye-doped liquid crystal units by one to one.

12. The liquid crystal display device according to claim 11, wherein a second electrode layer is disposed on one side of the second substrate adjacent to the first substrate, the second electrode layer comprises a plurality of second electrodes disposed at intervals, and the second electrodes correspond to the dye-doped liquid crystal units by one to one.

13. The liquid crystal display device according to claim 12, wherein the liquid crystal molecules are cholesteric liquid crystal molecules and have a positive polarity, the first state is a power-on state, and the second state is a power-off state.

14. The liquid crystal display device according to claim 12, wherein a first alignment film is disposed on one side of the first electrode layer away from the first substrate, and a second alignment film is disposed on one side of the second electrode layer away from the second substrate.

15. The liquid crystal display device according to claim 14, wherein the first alignment film and the second alignment film adopt a twisted nematic alignment method, the liquid crystal molecules have a positive polarity, the first state is a power-on state, and the second state is a power-off state.

16. The liquid crystal display device according to claim 14, wherein a polarizer is disposed on one side of the liquid crystal display panel adjacent to the backlight module, and the polarizer is configured to cooperate with the dye-doped liquid crystal units to allow the light incident on the dye-doped liquid crystal units to pass through when the dye-doped liquid crystal units are in the first state and to regulate the light incident on the dye-doped liquid crystal units when the dye-doped liquid crystal units are in the second state.

17. The liquid crystal display device according to claim 16, wherein the first alignment film and the second alignment film adopt a vertical alignment method, the liquid crystal molecules have a negative polarity, the first state is a power-off state, the second state is a power-on state, and a light-absorbing direction of the polarizer is perpendicular to a long axis direction of the liquid crystal molecules in the second state.

18. The liquid crystal display device according to claim 16, wherein the first alignment film and the second alignment film adopt an electrically controlled birefringence alignment method, the liquid crystal molecules have a positive polarity, the first state is a power-on state, the second state is a power-off state, and a light-absorbing direction of the polarizer is perpendicular to a long axis direction of the liquid crystal molecules in the second state.

19. The liquid crystal display device according to claim 9, wherein the liquid crystal display panel comprises a plurality of sub-pixel units, and the dye-doped liquid crystal units in the backlight module correspond to the sub-pixel units by one to one.

20. The liquid crystal display device according to claim 9, wherein the dye molecules comprise azo groups or anthraquinone groups.
